(19) United States
(12) Patent Application Publication
(10) Pub. No.: US 2022/0242728 A1
(43) Pub. Date: Aug. 4, 2022

(54) SYSTEM AND METHOD FOR OBTAINING POTABLE WATER FROM FOSSIL FUELS

(71) Applicant: Louis THEODORE, East Williston, NY (US)

(72) Inventor: Louis THEODORE, East Williston, NY (US)

(21) Appl. No.: 17/579,045

(22) Filed: Jan. 19, 2022

Related U.S. Application Data
(60) Provisional application No. 63/145,701, filed on Feb. 4, 2021.

(51) Int. Cl. C01B 5/00; B01D 53/26; B01D 5/00; C02F 1/10; B01J 12/00

(52) U.S. Cl. CPC C01B 5/00; B01D 53/265; F23L 7/007; C02F 1/10; B01J 12/00; B01D 5/0054

(57) ABSTRACT

A process of producing potable water, by combining a hydrocarbon containing fossil fuel with oxygen, in a combustion device, such as a home heating or utility unit to produce a flue gas of water vapor and carbon dioxide, and condensing the water vapor in the flue gas to yield potable water. The combustion device can produce heat or electricity. The water vapor can be condensed with one or more heat exchange devices. The source of oxygen can be air, pure oxygen, or nitrogen reduced air. The source of oxygen can be humidified, such as with a non-potable water source or non-potable water can be added to the flue gas. The carbon dioxide and/or nitrogen in the flue gas can be reduced or removed before the condensation step(s). The pressure of the flue gas can be increased prior to condensation of the water vapor. Natural gas is a preferred fuel.

### BACKGROUND OF THE INVENTION

The world's total water supply is enormous, compared to presently conceivable human needs. The oceans are vast. Yet, there is a growing shortage of potable water that is free from excess contaminants, salts and other chemicals. About ninety-nine percent of the 320 million cubic miles of water in or on the earth's crust is salty and useful neither for irrigation nor for the majority of society's other needs by present techniques. Other water is contaminated with organic and inorganic contaminants. One way to increase potable water availability is to develop processes for obtaining potable water from sea water or non-potable ground water. These processes typically employ membrane separations, distillations, crystallizations and so forth. However, despite significant efforts, prior attempts have fallen short of widespread acceptability and the worldwide need for potable water is growing.

Many states have established standards for classifying water as potable. These standards involve placing limits on any contamination by pathogens, such as bacteria, chemicals, such as benzene, and salts, such as sodium chloride. As used herein, the term potable water means that the water is sufficiently free from pathogens, restricted chemicals, and salts to comply with any federal drinking water standards, and the standards of the State of New York.

The dissolved salt in much of the naturally available water makes recovering natural potable water a worldwide challenge. Water that is “saline” contains significant concentrations of dissolved salts. The most common sodium chloride (NaCl). In this case, the concentration is the amount (by weight) of salt in water, as expressed in “parts per million” (ppm). If water has a concentration of 10,000 ppm of dissolved salts, then 10,000 divided by 1,000,000 of the weight of the water (1%) comes from dissolved salts.

Common parameters for saline water vary, and include:
Fresh water—Less than 500-1,000 ppm salt
Slightly saline water—From 1,000 ppm to 3,000 ppm salt
Moderately saline water—From 3,000 ppm to 10,000 ppm
Highly saline water—From 10,000 ppm to 35,000 ppm
Ocean water contains about 35,000 ppm of salt.

As used herein, the term potable water will mean water that contains under 750 ppm dissolved salts.

Processes have been proposed to use heat exchangers to heat fluids flowing therein with flue gas, following the combustion of fossil fuels in the power industry. This work has primarily been concerned with recovering heat from flue gas of commercial power plants for the purpose of operating the combustion device in a more thermodynamically efficient manner.

The various proposals for recovering water from power generation have not met widespread acceptance and have not fulfilled the goal of substantial recovery of potable water from fuel combustion.

Accordingly, the production of potable water from power generation and other combustion of fossil fuels has not become widely available. It is therefore desirable to provide new processes for providing potable drinking water that avoid the drawbacks of prior processes.

### SUMMARY OF THE INVENTION

The invention comprises the recovery of potable water from home heating or utility based combustion of fossil fuels, such as oil and especially natural gas. Advantages can be obtained by decentralizing water production and producing drinking water simultaneously with home heat and/or home power generation from natural gas combustion, to provide a process specifically to generate potable water from the flue gas discharged from natural gas-fired home heating boilers.

An improved process of obtaining potable water from the combustion of fossil fuels is provided, which preferably employs a feedstock that is high in hydrogen content and low in impurities that can taint the generated water, such as natural gas. The Water Obtained from Fossil Fuel (WOFF) process described herein can produce water for any useful purpose, such as irrigation, but primarily for potable uses. No existing process overcomes the drawbacks needed to accomplish this objective.

Processes in accordance with the invention include burning natural gas to generate heat and/or electricity, and flue gas containing carbon dioxide, water vapor, and other byproducts. The flue gas is subjected to a first condensation with any known condensation device, such as a first heat exchanger to produce a first stream of condensed water vapor, with a first level of contamination from combustion byproducts, and a first stream of non-condensed flue gas. By operating the furnace properly and using relatively pure fuels, such as natural gas, especially purified natural gas, the first stream of condensed water vapor can be potable water. In addition to condensing the vapor by cooling its temperature, water vapor can be condensed by increasing its pressure, or both

In the case where this first stream of condensed water vapor is too impure for desired needs, the non-condensed flue gas exiting the first heat exchanger can be sent to a second heat exchanger, which produces a second stream of condensed water vapor. This second stream comprises potable water. Any still uncondensed water vapor can be sent to a third heat exchanger, and so forth, or vented to the atmosphere.

Other advantages and objects of the invention will be apparent from the descriptions to follow.

### DESCRIPTION OF THE DRAWINGS

FIG. 1 is a schematic view of a system for producing potable water in accordance with a preferred embodiment of the invention; and

FIG. 2 is a schematic view of a multiple heat exchanger embodiment of a system for producing potable water in accordance with a preferred embodiment of the invention.

### DETAILED DESCRIPTION OF THE PREFERRED EMBODIMENTS

Potable water can be obtained (as described herein) by the chemical combination of hydrogen from fossil fuels, especially natural gas, with oxygen from the air. One such decentralized process is employed for home heating and/or electricity generation. This combustion processes involves the combination of a fossil fuel and oxygen to produce water vapor and carbon dioxide. The water produced and present in the flue gas as vapor is generally viewed as a by-product of heat production and vented to the atmosphere as waste gas. However, the water in the flue gas can be converted to potable drinking water or water for other purposes.

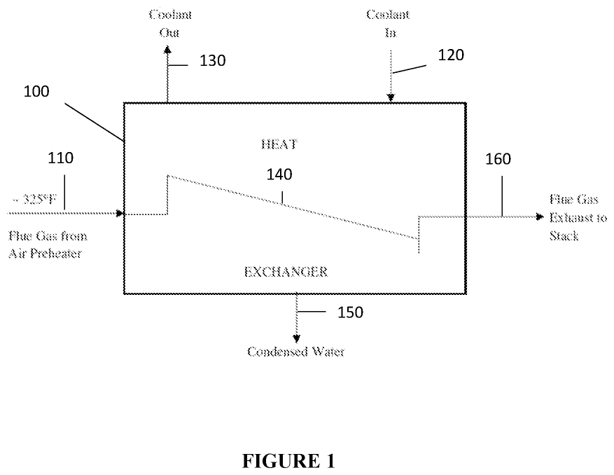

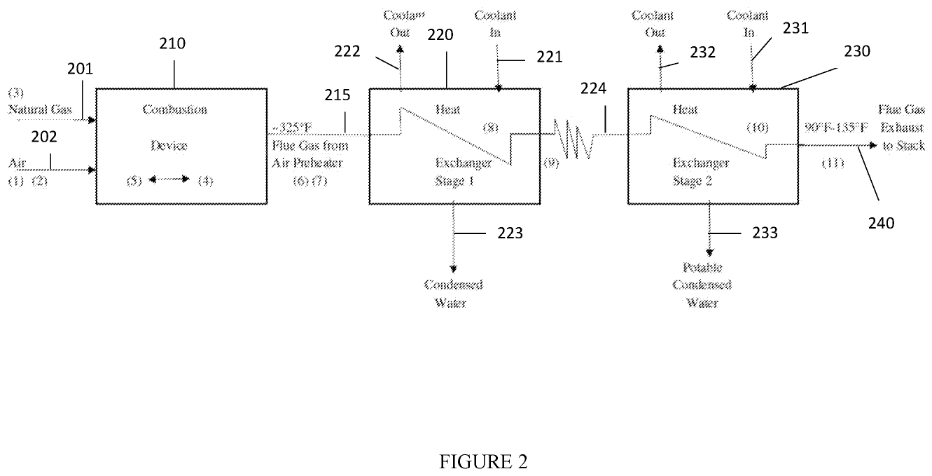

The “WOFF” process for producing water from fossil fuel, described herein is depicted in FIGS. 1 and 2.

It has been determined that by conducting multiple condensations on the same flue gas stream, the purity of the water can be improved by, e.g., the removal of acids and other impurities that can undesirably be present in flue gas. This process also allows a host of options that may be employed to not only provide pure(r) water but also improve the quality of water that can be extracted from the flue gas.

In a first embodiment of the invention, a heat exchanger 100 is shown generally in FIG. 1. A flue gas stream 110 from a power plant contains water vapor, carbon dioxide, and possibly other combustion byproducts. Stream 110 enters heat exchanger 100 from a combustion furnace or an air preheater (not shown) at a temperature above the boiling point of water, for example, at 325° F. A coolant stream 120 enters heat exchanger 100 at below the condensation temperature of water and is used to condense the water vapor in a cooled flue gas stream 140 within heat exchanger 100. A heated coolant stream 130 at an elevated temperature, a cooled flue gas exhaust 160 at a reduced temperature, and a flow of condensed water 150, all exit heat exchanger 100. Under many situations, condensed water 150 will be potable.

Referring to FIG. 2, a combustion device 210 receives an input of a natural gas stream 201 and an air stream 202. Combustion device 210 is preferably a natural gas furnace for producing heat in a home or can be a utility or other combustion device. A flue gas stream 215 exits combustion device 210. Flue gas stream 215 includes water vapor, carbon dioxide and can often also include undesirable contaminants.

Flue gas stream 215 will typically be at a temperature of about 325° F., especially if exiting from an air preheater (not shown). Flue gas stream 215 is then fed to a first heat exchanger 220. Heat exchanger 220 receives an inflow of coolant 221. Coolant inflow 221 is preferably at a temperature range adequate to condense the water in the flue gas. Coolant inflow 221 is used to partially condense the water vapor in flue gas 215. This will produce a first condensed water stream 223 which may be potable and a warmed coolant outflow 222.

A first partially condensed flue gas stream 224 will exit first heat exchanger 220. First partially condensed stream 224 will contain water vapor. Stream 224 is fed to a second heat exchanger 230. Second heat exchanger 230 includes a second coolant inflow stream 231 at a temperature adequate to condense water vapor in stream 224. Water vapor from stream 224 will condense and exit as a potable water stream 233. Warmed coolant will exit heat exchanger 230 as a warmed coolant outflow 232.

A stream of twice cooled/condensed flue gas 240 will exit second heat exchanger 230. This flue gas can be subjected to a third condensation process with an additional heat exchanger, or vented to a stack.

Some of the steps referred to above can be enhanced by the steps listed below, with reference to numerals (1)-(11) in FIG. 2 corresponding to the numbered steps listed below.
(1) Employ an oxygen enriching membrane, e.g., polydimethylsiloxane blended with polysulfide, to increase the oxygen concentration of the feed combustion air.
(2) Humidify the feed combustion air via any suitable means, e.g., employing the energy liberated in the combustion process to heat the air with any source of water, including seawater or other sources of potable or non-potable water.
(3) Humidify the natural gas feed with available water sources, including potable or non-potable water, such as ground water or sea water.
(4) Produce elemental carbon in the combustion unit via a catalytic process. This can also reduce greenhouse gas emission.
(5) Produce carbon monoxide in the combustion unit via a catalytic process to supply more oxygen for water production.
(6) Employ a polymer-type membrane, e.g., Nafron, to improve the water separation process.
(7) Increase the pressure of the flue gas via any suitable means, e.g., employing the energy liberated in the combustion process to enhance water condensation.
(8) Decrease the temperature of the flue gas via any suitable means, e.g., a heat exchanger, to enhance water condensation.
(9) Increase the pressure and/or decrease the temperature of the flue gas.
(10) Employ a two-or-more stage heat exchanger to remove impurities (including acid gases) from the flue gas.
(11) Employ refrigeration to (further) cool the flue gas.
In another preferred embodiment of the invention, the WOFF process can be enhanced and/or water purification efforts can be enhanced, by vaporizing seawater or other non-potable water during the combustion process and mixing this water vapor with the flue gas. For example, seawater can be sprayed into the flue gas and the water therein will instantly vaporize and increase the water percentage of the flue gas. The dissolved salts will fall out as solid impurities and can be removed by well understood devices and methods. Thus, a desalination option may also be employed where seawater feed, with or without a fossil fuel feed, is introduced to the combustion device. Although reducing the thermodynamic efficiency associated with the fossil fuel (from an energy perspective) of the process, the non-potable water in the feed that is evaporated, will increase the (potable) water content removable from the flue gas.

In addition to the above, where hydrogen is obtained from a fossil fuel and oxygen is obtained from air, any other source of hydrogen and source of oxygen—as with an acid and a base to form a salt and water—can be employed.

It should be noted that there are technologies available that can separate oxygen from air, and water from flue gas, but these technologies are still not well optimized or cost-effective enough that they are widely used. Cryogenic distillation towers are still widely used to remove oxygen from air while condensation towers might be preferred for water removal from the flue gas; however, these are inherently very energy-consumptive. Membrane technology holds significant potential to make these gas separations more energy efficient. The literature has also reported that if distillation were replaced by membrane separation, 90% or more energy would be saved in the industrial refinery sector. Thus, membranes can and should play an important role in the WOFF process. The aforementioned Nafron (doped with silver) can separate oxygen from nitrogen in the air and using a permeable membrane with nanoparticles that has hydrophilic properties (so that water vapor would pass through it faster than nitrogen) could effectively separate water vapor from the flue gas.

### EXAMPLE

The following example is provided for illustration only and is not to be interpreted as limiting the scope of the invention.

Although many fossil fuels and related compounds may be employed in the WOFF process, the combustion of natural gas, consisting primarily of methane (having the highest ratio of hydrogen to carbon), with stoichiometric air, would be the most preferred choice from a process and economic perspective. (See also Equation 1 below). One can show that for this WOFF case, the water present (approximately 20% by volume in the flue gas) will condense—as relatively pure potable water—when the temperature is cooled to below about 150° F., preferably below about 140° F., most preferably about 138.5° F. The fossil fuel propane scenario produces a temperature of 130.8° F. These represent the temperatures at which water will start to condense. Furthermore, approximately 50% and 75% of the water will condense at 112° F. and 90° F., respectively. These calculations are based on the combustion of natural gas (95% CH₄, 5% C₃H₈) producing a partial pressure of H₂O in the 0.155-0.190 atm range, with a corresponding saturated (dew point) temperature of approximately 135° F. Similar calculations have been performed for other classes of fossil fuels. These calculations indicate that if the WOFF flue gas produced from the combustion of natural gas is cooled below approximately 135° F., then H₂O will start to condense. It has been determined that more water will be condensed as the temperature is decreased (or pressure increased). As noted, 50% of the water present will condense if the temperature is reduced to approximately 112° F. and approximately 75% of the water will condense at approximately 90° F.

For the former case, a typical home heating system would annually produce approximately 2,500 lbs of H₂O if the flue gas condensation were operated at 112° F. and 1.0 atm.

Note that stoichiometric air is employed for all of these calculations. Air is about 80% nitrogen. One preferred embodiment of the invention employs stoichiometric oxygen as opposed to stoichiometric air. This eliminates the nitrogen in the flue gas and produces a significantly higher water concentration, i.e., the partial pressure of water vapor in the flue gas. (See also Equation 2.) The flue gas will also produce less, if any nitrogen-based acid impurities.

The “WOFF” process can be enhanced by producing elemental carbon (carbon black/graphite) via a catalytic process. This requires less air (and thus less nitrogen) and produces no carbon dioxide, thus increasing the concentration of water vapor. Although half the energy normally generated is lost, it can be recovered if the carbon is later combusted to form carbon dioxide. (See also Equation 3).

The WOFF process can be enhanced by producing carbon monoxide rather than carbon dioxide via the incomplete combustion of methane. This will marginally increase the concentration of water vapor. (See also Equation 4.)

The WOFF process can also be enhanced by the host of operations that were presented in the previous section.

$$1. {CH}_{4} + 2 {O}_{2} + 7.53 {N}_{2} \to {CO}_{2} + 2 {H}_{2} O + 7.53 {N}_{2} ( flue gas ) \qquad ( 1 )$$

$$Concentration of water vapor = \frac{2}{1 + 2 + 7.53} = \frac{2}{10.53} = 0.19 = 19 \%$$

$$2. {CH}_{4} + 2 {O}_{2} \to {CO}_{2} + 2 {H}_{2} O ( flue gas ) \qquad ( 2 )$$

$$Concentration of water vapor = \frac{2}{1 + 2} = 0.67 = 67 \%$$

$$3. {CH}_{4} + {O}_{2} + 3.77 {N}_{2} \to C ↓ + 2 {H}_{2} O + 3.77 {N}_{2} ( flue gas ) \qquad ( 3 )$$

$$Concentration of water vapor = \frac{2}{2 + 3.77} = 0.35 = 35 \%$$

$$4. {CH}_{4} + 1.5 {O}_{2} + 5.65 {N}_{2} \to CO + 2 {H}_{2} O + 5.65 {N}_{2} ( flue gas ) \qquad ( 4 )$$

$$Concentration of water vapor = \frac{2}{1 + 2 + 5.65} = 0.23 = 23 \%$$

Based on the above WOFF calculations, one can apply the WOFF process to not only a power plant, e.g., burning oil or natural gas, but also to small domestic (or commercial) units for generating water that is either potable or water that can be further easily treated by traditional methods to insure that it is potable. It has been shown by the USEPA and USDOE that the combustion of natural gas (a clean fossil fuel) produces only trace quantities of undesirable gases and of which only trace quantities will be absorbed by the condensed water. These amounts can be reduced by multiple condensations to increase the water purity.

Preliminary economic calculations indicate that the cost for producing byproduct water from a WOFF energy combustion process employing natural gas are favorable.

As discussed above, a process in accordance with the invention can be designed to recover water from the combustion of any fossil fuel, including:

| | |
|---|---|
| a. | Natural gas |
| b. | Oil |
| c. | Coal |
| d. | Shale |
| e. | Tar sand |

Any known combustion equipment or any energy conversion device, including utility boilers, domestic boilers, diesel engines, thermal and catalytic reactors, etc., may be employed.

Various steps can be used to improve the process. For example, it is advantageous to remove nitrogen from the flue gas produced in the combustion process (e.g., selective adsorption).

It is advantageous to remove carbon dioxide from the flue gas produced in the combustion process.

It is advantageous to convert the carbon in the fossil fuel to either elemental carbon and/or carbon monoxide.

It is advantageous to enhance the condensation of water vapor in a flue gas by increasing the pressure of the condensation system.

It is advantageous to enhance the condensation of water by both increasing the pressure and decreasing the temperature of the condensation process via any suitable means.

It is advantageous to employ nitrogen depleted air, including operations involving membranes.

It is advantageous to employ natural gas (or a fossil fuel) containing water vapor.

It is advantageous to humidify the combustion air prior to combustion, such as by employing the energy liberated in the combustion process to heat the air with any source of water, including seawater.

It is advantageous to employ a two (or multi) stage heat exchanger (condenser) to enhance acid gas removal.

It is advantageous to employ the energy (heat of combustion) to cool the flue gas via refrigeration and/or pressurize the flue gas.

It is advantageous to introduce seawater feed, with or without the fossil fuel, to the combustion device to increase the water content of the feed.

Any combination of the above.

In addition to the WOFF process, other non-desalination processes involving the combination of hydrogen from one source and oxygen from another (or same) source may be employed.

What is claimed is:

1. A process of producing potable water, comprising:
combining a fossil fuel with oxygen in a combustion device to produce a flue gas including water vapor and carbon dioxide;
condensing the water vapor in the flue gas; and
producing potable water as the condensed water vapor from the flue gas.

2. The process of claim 1, herein the combustion device is a home natural gas furnace.

3. The process of claim 2, wherein the water vapor is condensed with a heat exchange device.

4. The process of claim 1, wherein the heat exchange device is a multi-stage heat exchanger, a distillation device or multiple heat exchangers.

5. The process of claim 1, wherein the source of oxygen comprises a source of pure oxygen.

6. The process of claim 1, wherein the source of oxygen is humidified with a source of non-potable water.

7. The process of claim 1, wherein non-potable water is sprayed into the flue gas before it is condensed.

8. The process of claims 1, wherein the carbon dioxide and/or nitrogen in the flue gas is reduced or removed before the condensation step.

9. The process of claims 1, wherein the pressure of the flue gas is increased prior to condensation.

10. The process of claims 1, wherein the hydrocarbon fuel is natural gas.

11. The process of claims 1, wherein the combustion device is a home heating unit.

12. The process of claim 1, wherein the flue gas is cooled to below 150° F. to condense the water vapor.

13. The process of claim 1, wherein the flue gas is cooled to below 112° F. to condense the water vapor.

14. The process of claim 1, and producing 2,500 pounds of water.

15. A system for producing potable water, comprising:
a fuel inlet adapted to receive a flow of natural gas and an air inlet adapted to receive a flow of air, containing a quantity of oxygen;
a natural gas combustion device having the fuel inlet and a flue, adapted to receive the natural gas and oxygen, combust the natural gas and produce a flue gas comprising carbon dioxide and water vapor out the flue;
a first water vapor condensation device adapted to condense the water vapor in the flue gas into a first quantity of potable water;

16. The system of claim 15, and comprising a second condensation device adapted to condense any of the flue gas not condensed by the first condensation device and produce a second quantity of potable water.

17. The system of claim 15, wherein the first water condensation device comprises a heat exchanger.

18. The system of claim 16, wherein the second water condensation device comprises a heat exchanger.
